(19) United States
(12) Patent Application Publication
(10) Pub. No.: US 2026/0129347 A1
(43) Pub. Date: May 7, 2026

(54) EARPHONES

(71) Applicant: SHENZHEN SHOKZ CO., LTD., Shenzhen (CN)

(72) Inventors: Jianing LIANG, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/435,694

(22) Filed: Dec. 29, 2025

Related U.S. Application Data
(63) Continuation of application No. PCT/CN2024/095600, filed on May 27, 2024.

(51) Int. Cl. H04R 1/10; H04R 1/02; H04R 1/22; H04R 7/16

(52) U.S. Cl. CPC H04R 1/1075; H04R 1/02; H04R 1/22; H04R 7/16

(57) ABSTRACT

An earphone is provided. The first speaker includes a first diaphragm. The first diaphragm and a core housing cooperate to form a first front cavity and a first rear cavity located on two sides of the first diaphragm. The second speaker includes a second diaphragm and a speaker housing. The second diaphragm, the speaker housing, and the core housing cooperate to form a second front cavity and a second rear cavity located on two sides of the second diaphragm. The core housing is provided with a first sound outlet for guiding a sound from the first front cavity to outside of the core housing and a second sound outlet for guiding a sound from the second front cavity to the outside of the core housing. The second speaker is further provided with a communication hole for communicating the second rear cavity with outside of the second speaker.

### CROSS-REFERENCE TO RELATED APPLICATIONS

This application is a continuation of International Patent Application No. PCT/CN2024/095600, filed on May 27, 2024, the contents of which are hereby incorporated by reference.

### TECHNICAL FIELD

The present disclosure generally relates to the field of electronic devices, and in particular to earphones.

### BACKGROUND

With the development of acoustic technology, earphones have been widely used in people's daily lives. An earphone may use a combination of a plurality of speakers to output a sound to provide an auditory feast for a user. During the use of the earphones, different speakers may be responsible for outputting sounds in different frequency bands. Generally, a plurality of speakers that emit sounds in different frequency bands may adopt a driving manner of single-channel electrical signal driving or multi-channel electrical signal driving. When the single-channel electrical signal driving is adopted, since the diaphragm of a speaker responsible for outputting a sound in a relatively high frequency band is usually thin, the diaphragm may experience excessive amplitude when receiving a low-frequency signal, leading to distortion that compromises sound quality and user experience.

### SUMMARY

Embodiments of the present disclosure provide an earphone. The earphone may include: a core housing; a first speaker; a second speaker; and a driving circuit. The core housing accommodates the first speaker and the second speaker. The driving circuit is configured to drive the first speaker and the second speaker. At least a portion of a frequency band of a sound output by the first speaker is lower than a frequency band of a sound output by the second speaker. The first speaker includes a first diaphragm. The first diaphragm and the core housing cooperate to form a first front cavity and a first rear cavity located on two sides of the first diaphragm. The second speaker includes a second diaphragm and a speaker housing. The second diaphragm, the speaker housing, and the core housing cooperate to form a second front cavity and a second rear cavity located on two sides of the second diaphragm. The core housing is provided with a first sound outlet for conducting a sound from the first front cavity to outside of the core housing, and a second sound outlet for conducting a sound from the second front cavity to the outside of the core housing. The second speaker is further provided with a communication hole for communicating the second rear cavity with outside of the second speaker.

In some embodiments, when the driving circuit drives the second speaker, an operating frequency of the driving circuit includes a frequency band not higher than 200 Hz.

In some embodiments, the driving circuit is configured to simultaneously drive the first speaker and the second speaker through a digital-to-analog conversion circuit.

In some embodiments, a resonant frequency of the second speaker is not lower than 6 kHz.

In some embodiments, an acoustic impedance at the communication hole is in a range of 5×10⁸ Pa·s/m-1.3×10⁹ Pa·s/m, and/or an acoustic mesh is provided at the communication hole.

In some embodiments, the second speaker is further provided with a second magnetic circuit system, the communication hole penetrates through the second magnetic circuit system, and an aperture of the communication hole is in a range of 0.8 mm-1.2 mm.

In some embodiments, in a radial direction of the second diaphragm, the communication hole is centrally provided relative to the second diaphragm.

In some embodiments, on a reference plane perpendicular to an axial direction of the first speaker, at least a portion of an orthogonal projection of the second speaker on the reference plane overlaps with an orthogonal projection of the first speaker on the reference plane; an axial direction of the second speaker points toward the first speaker; and the communication hole is provided facing inside of the core housing.

In some embodiments, the earphone further includes a communication tube provided inside the core housing. One end of the communication tube is in communication with the communication hole, and the other end of the communication tube is in communication with the outside of the core housing.

In some embodiments, the second speaker is located in the first front cavity, and the second rear cavity and the first front cavity are in communication with each other through the communication hole.

In some embodiments, an audio driving signal output by the driving circuit is configured to be directly input to the second speaker without undergoing frequency-dividing processing.

### BRIEF DESCRIPTION OF THE DRAWINGS

To more clearly illustrate the technical solutions in the embodiments of the present disclosure, the drawings used in the description of the embodiments will be briefly introduced below. Obviously, the drawings in the following description are only some embodiments of the present disclosure. For those of ordinary skill in the art, other drawings may be obtained based on the drawings without creative effort.

FIG. 1 is a schematic diagram illustrating a structure of an earphone according to some embodiments of the present disclosure;

FIG. 2 is a schematic diagram illustrating a structure of the earphone in FIG. 1 from another perspective according to some embodiments of the present disclosure;

FIG. 3 is a schematic diagram illustrating a structure of the earphone in FIG. 1 from yet another perspective according to some embodiments of the present disclosure;

FIG. 4 is a schematic diagram illustrating a front profile of an ear of a user or a simulator according to some embodiments of the present disclosure;

FIG. 5 is a schematic diagram illustrating the earphone in FIG. 1 in a wearing state according to some embodiments of the present disclosure;

FIG. 6 is a cross-sectional view of the earphone in FIG. 1 taken along a line VI-VI according to some embodiments of the present disclosure;

FIG. 7 is a cross-sectional view of the earphone in FIG. 1 taken along a line VII-VII according to some embodiments of the present disclosure;

FIG. 8 is a schematic diagram illustrating a structure of a first housing in FIG. 6 according to some embodiments of the present disclosure;

FIG. 9 is a circuit schematic diagram of a speaker assembly according to some embodiments of the present disclosure;

FIG. 10 is a schematic diagram illustrating frequency division effects of a second speaker 122 under different frequency-dividing processing conditions when adjusting a high-pass frequency divider 1304 according to some embodiments of the present disclosure;

FIG. 11 is a schematic diagram illustrating a structure of a second speaker in FIG. 7 according to some embodiments of the present disclosure; and

FIG. 12 is a schematic diagram illustrating a portion of a structure of a core module in FIG. 11 according to some embodiments of the present disclosure.

### DETAILED DESCRIPTION

The present disclosure is described in further detail below with reference to the accompanying drawings and embodiments. It is specifically pointed out that the following embodiments are merely for illustrating the present disclosure and do not limit the scope of the present disclosure. Similarly, the following embodiments are only part of the embodiments of the present disclosure and not all embodiments. All other embodiments obtained by those of ordinary skill in the art based on the embodiments of the present disclosure, without creative efforts, fall within the protection scope of the present disclosure.

Reference to “an embodiment” in the present disclosure means that a particular feature, structure, or characteristic described in connection with the embodiment may be included in at least one embodiment of the present disclosure. It is explicitly and implicitly understood by a person skilled in the art that the embodiments described in the present disclosure may be combined with other embodiments.

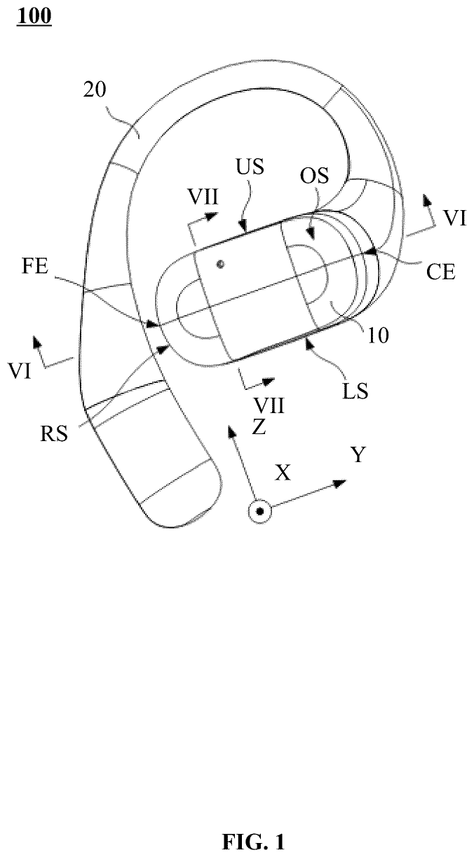

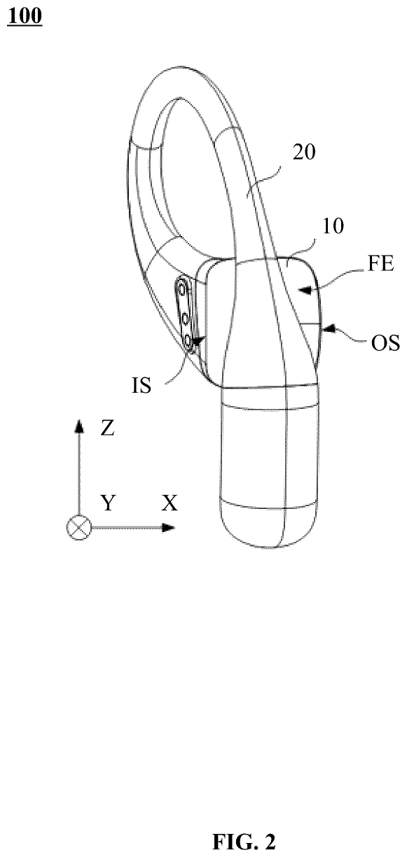

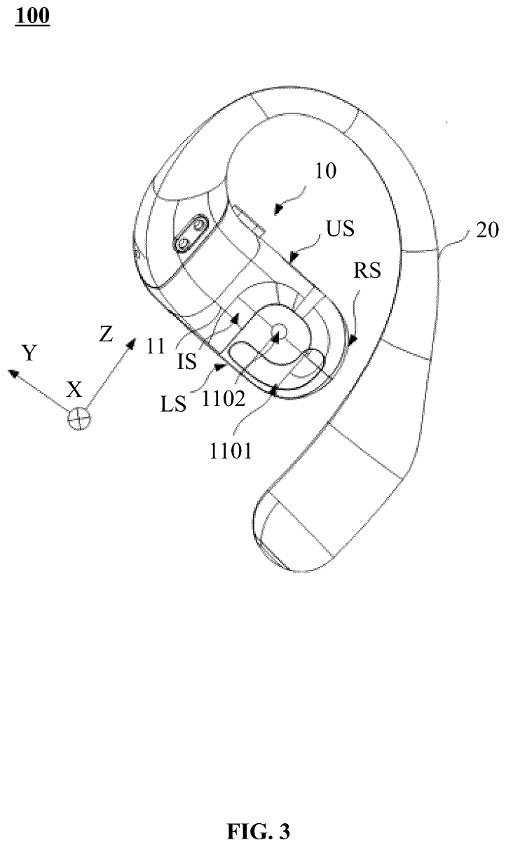

The present disclosure describes an earphone. Please refer to FIG. 1, FIG. 2, and FIG. 3, FIG. 1 is a schematic diagram illustrating a structure of an earphone according to some embodiments of the present disclosure, FIG. 2 is a schematic diagram illustrating a structure of an earphone in FIG. 1 from another perspective according to some embodiments of the present disclosure, and FIG. 3 is a schematic diagram illustrating a structure of an earphone in FIG. 1 from yet another perspective according to some embodiments of the present disclosure. The earphone 100 may include a core module 10 and a hook structure 20 connected to the core module 10. The core module 10 may provide a sound to achieve an auditory experience. Certainly, the core module 10 may also have other functions, such as a sound pickup function, a touch control function, a press function, or a lighting function, to achieve different experiences. The core module 10 may cooperate with the hook structure 20 to achieve wearing.

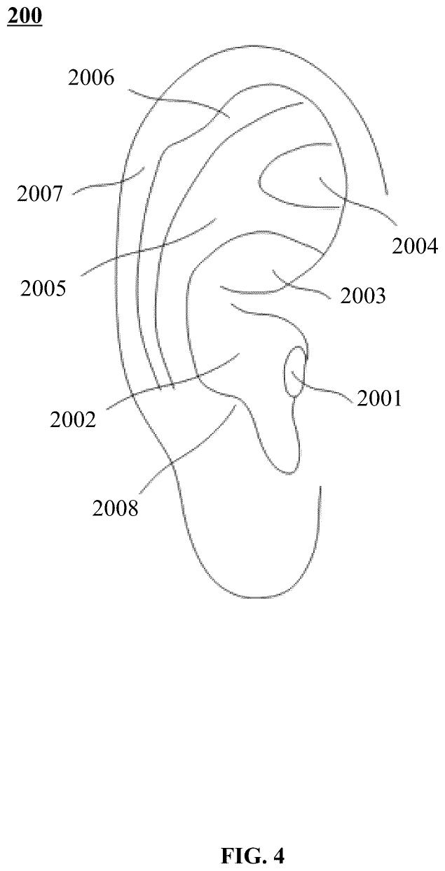

Please refer to FIG. 4, FIG. 4 is a schematic diagram illustrating a front profile of an ear of a user or a simulator according to some embodiments of the present disclosure. An ear 200 may include physiological parts such as an ear canal 2001, a cavum concha 2002, a cymba concha 2003, a triangular fossa 2004, an antihelix 2005, a scaphoid fossa 2006, a helix 2007, and an antitragus 2008. The ear canal 2001 has a certain depth and may extend to the eardrum. However, for ease of description, the ear canal 2001 may refer to an ear hole of the ear 200 in the present disclosure unless otherwise specified. In addition, physiological parts such as the cavum concha 2002, the cymba concha 2003, and the triangular fossa 2004 may also have a certain volume and depth. The cavum concha 2002 may be directly connected to the ear canal 2001, i.e., the ear hole may be considered to be located at a bottom of the cavum concha 2002.

It is understandable that there may be individual differences among different users, resulting in dimensional differences in the ear 200, such as different shapes and sizes. To facilitate description and reduce (or even eliminate) individual differences among different users, a simulator containing a head and ears (typically including left and right ears; here, one ear is used as an example) 200 may be manufactured based on standards such as ANSI S3.36, ANSI S3.25, and IEC 60318-7, for example, GRAS 45BC KEMAR, HEAD Acoustics, B&K 4128 series, or B&K 5128 series, etc. The simulator is used to represent a scenario in which most users wear the earphone 100. Taking GRAS KEMAR as an example, the simulator for the ear 200 may be any one of GRAS 45AC, GRAS 45BC, GRAS 45CC, GRAS 43AG, or the like. Taking HEAD Acoustics as an example, the simulator for the ear 200 may be any one of HMS II.3, HMS II.3 LN, HMS II.3LN HEC, or the like.

It should be noted that in fields such as medicine and anatomy, three basic planes, including a sagittal plane, a coronal plane, and a horizontal plane, and three basic axes, including a sagittal axis, a coronal axis, and a vertical axis, may be defined for a human body or a human body simulator. The sagittal plane refers to a vertical plane cut along an anterior-posterior direction of the human body, which divides the human body or the human body simulator into left and right parts. The coronal plane refers to a vertical plane cut along a left-right direction of the human body, which divides the human body or the human body simulator into anterior and posterior parts. The horizontal plane refers to a transverse plane cut along a superior-inferior direction of the human body, which divides the human body or the human body simulator into superior and inferior parts. Correspondingly, the sagittal axis refers to an axis along the antero-posterior direction of the human body and perpendicular to the coronal plane. The coronal axis refers to an axis along the left-right direction of the human body and perpendicular to the sagittal plane. The vertical axis refers to an axis along the superior-inferior direction of the human body and perpendicular to the horizontal plane. Furthermore, the “front side of the ear” described in the present disclosure is a concept relative to the “rear side of the ear”. The former refers to a side of the ear away from the head, and the latter refers to a side of the ear toward the head. Both are directed to the ear 200 of the user or the simulator. When observing the ear 200 of the human body or the simulator along a direction of the coronal axis, the ear 200 may be as shown in FIG. 4.

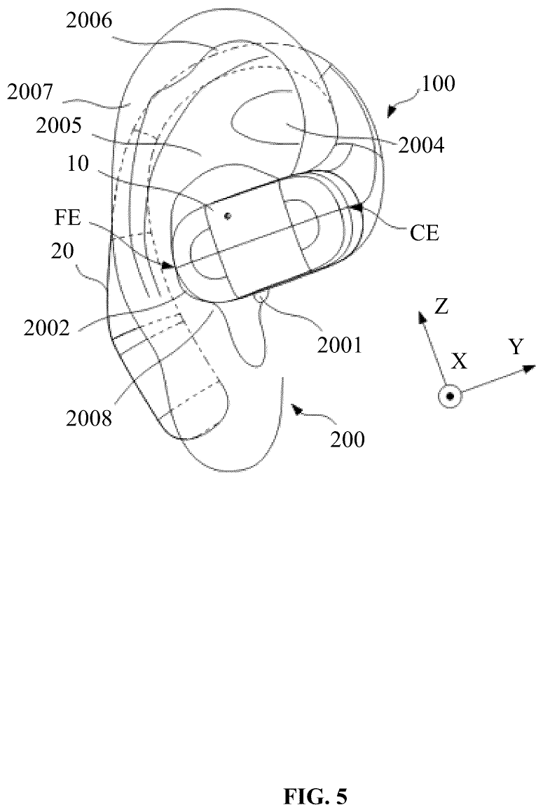

Please refer to FIG. 5, FIG. 5 is a schematic diagram illustrating an earphone 100 in FIG. 1 in a wearing state according to some embodiments of the present disclosure. The core module 10 is located on the front side of the ear 200 in the wearing state. At least a portion of the hook structure 20 is located on the rear side of the ear 200 in the wearing state, ensuring that the earphone 100 is hung on the ear 200 in the wearing state.

In the present disclosure, descriptions such as “wearing the earphone 100,” “the earphone 100 is in the wearing state,” and “in the wearing state,” when describing the process or action of wearing the earphone 100, may all refer to the earphone 100 being worn on the ear 200. Certainly, precisely because individual differences exist among users, there may be some differences when the earphone 100 is worn by different users compared to when the earphone 100 is worn on the ear 200 of the simulator, but such differences should be tolerable.

The core module 10 may be configured not to block the ear canal 2001 in the wearing state, making the earphone 100 an “open earphone.” It is understandable that in different wearing states, the earphone 100 may make the core module 10 partially block the ear canal 2001, but the ear canal 2001 remains unblocked.

Please refer to FIG. 1, FIG. 2, and FIG. 3, the core module 10 may have a connection end CE connected to the hook structure 20 and a free end FE not connected to the hook structure 20. In the wearing state, the free end FE of the core module 10 may extend into the cavum concha 2002, or may only cover at least a portion of the cavum concha 2002. The core module 10 and the hook structure 20 may be configured to clamp the ear 200 from the front and rear sides of a region of the ear 200 corresponding to the cavum concha 2002, thereby increasing the resistance of the earphone 100 to falling off from the ear 200, and thus improving the stability of the earphone 100 in the wearing state.

The core module 10 may have a thickness direction X, and a length direction Y and a width direction Z that are perpendicular to the thickness direction X and orthogonal to each other. In some embodiments, the length direction Y may be defined as a direction in which the core module 10 moves toward or away from the back of the head in the wearing state. The width direction Z may be defined as a direction in which the core module 10 moves toward or away from the top of the head in the wearing state. The thickness direction X may be defined as a direction in which the core module 10 faces toward or away from the user's ear in the wearing state. In some embodiments, the length direction Y may be defined as a direction from the connection end of the core module 10 to the free end of the core module 10, and the thickness direction X may be defined as a direction in which the core module 10 faces toward or away from the user's ear in the wearing state. In some embodiments, the free end FE presses against the inside of the cavum concha 2002 along the thickness direction X. As another example, the free end FE abuts against the inside of the cavum concha 2002 along the length direction Y and the width direction Z.

It should be noted that in the wearing state, in addition to extending into the cavum concha 2002, an orthogonal projection of the free end FE of the core module 10 may fall on the antihelix 2005, or may fall on the left and right sides of the head at a position located on the sagittal axis and in front of the ear 200.

Certainly, in other scenarios, the orthogonal projection of at least a portion of the core module 10 may also fall on the antihelix 2005, or may fall on the left and right sides of the head at the position located on the sagittal axis and in front of the ear 200.

In other words, the hook structure 20 may support the core module 10 to be worn in wearing positions such as the cavum concha 2002, the antihelix 2005, or the front side of the ear 200.

Please refer to FIG. 1, FIG. 2, and FIG. 5, in the wearing state and when observed along the direction of the coronal axis, the core module 10 may be configured in a shape such as a circular, an elliptical, a rounded square, a rounded rectangle, or the like. Therefore, for ease of description, the embodiment uses the core module 10 configured as a rounded rectangle as an example for illustrative description. In some embodiments, a length of the core module 10 in the length direction Y may be greater than a width of the core module 10 in the width direction Z.

The core module 10 may have an inner side surface IS facing the ear 200 in the wearing state along the thickness direction X, an outer side surface OS facing away from the ear 200, and a connection surface (e.g., a lower side surface LS, an upper side surface US, a rear side surface RS, etc.) connecting the inner side surface IS and the outer side surface OS. When the core module 10 is in the wearing state, the upper side surface US connects the inner side surface IS and the outer side surface OS. The lower side surface LS connects the inner side surface IS and the outer side surface OS. The upper side surface US is closer to the top of the head of the user along the width direction Z. The lower side surface LS is farther from the top of the head of the user along the width direction Z. The rear side surface RS connects the upper side surface US and the lower side surface LS, and may also connect the inner side surface IS and the outer side surface OS. The thickness direction X may also be defined as a direction in which the core module 10 moves toward or away from the ear 200 in the wearing state. At least a portion of the connection surface, such as the rear side surface RS, is located within the cavum concha 2002 in the wearing state and forms a first contact region with the front side of the region of the ear 200. That is, the rear side surface RS may be located at an end of the length direction Y toward the back of the head in the wearing state, and at least partially located in the cavum concha 2002. In some embodiments, the hook structure 20 forms a second contact region with a rear side of the region of the ear 200 in the wearing state. The second contact region and the first contact region at least partially overlap in an ear thickness direction of the region of the ear 200. Furthermore, the core module 10 and the hook structure 20 may jointly clamp the ear 200 from the front and rear sides of the ear 200. Clamping force is mainly compressive stress, which is beneficial for improving the stability and comfort of the earphone 100 in the wearing state. In some embodiments, when the core module 10 is configured as a shape such as a circular, an elliptical, or the like, the connection surface may also refer to an arc-shaped side surface of the core module 10.

It should be noted that terms such as “first,” “second,” and “third” in the present disclosure are used for descriptive purposes only and may not be construed as indicating or implying relative importance or implicitly specifying the quantity of the indicated technical features. Thus, features defined by terms such as “first,” “second,” and “third” may explicitly or implicitly include at least one such feature. In the description of the present disclosure, the meaning of “a plurality of” is at least two, e.g., two, three, etc., unless explicitly defined otherwise.

It is understandable that the core module 10 may also be worn directly or through other means, or even be connected and cooperate with other structures in coordination with the hook structure 20 to achieve wearing. Furthermore, when implementing the functions of the core module 10, it is not limited to the embodiments listed in the present disclosure. In some embodiments, the hook structure 20 may be omitted or replaced with other structures.

Additionally, when a wearing manner of the core module 10 changes, a cooperation manner between the core module 10 and the ear 200 may also change. However, in some embodiments, the changes do not necessarily cause changes to an internal structure, overall construction, external structure, etc., of the core module 10. Even in some embodiments, terms involving orientation, such as the lower side surface LS, the upper side surface US, and the rear side surface RS, may not necessarily correspond to the ear 200. Certainly, in some embodiments, terms such as the connection end CE may merely become terms involving orientation, and do not necessarily imply the inclusion of a specific function.

Furthermore, when the wearing manner of the core module 10 changes, the core module 10 may not cooperate with the hook structure 20 or other structures at the connection end CE to achieve wearing.

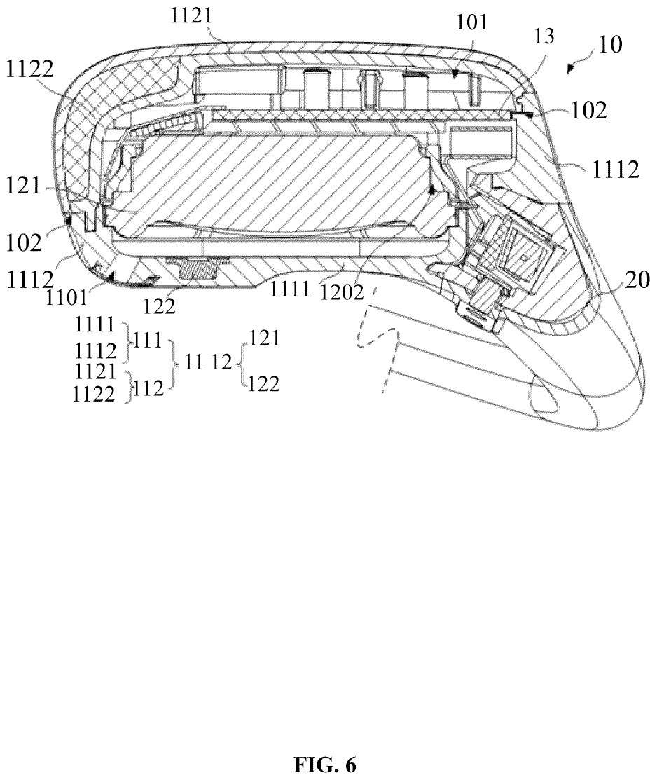

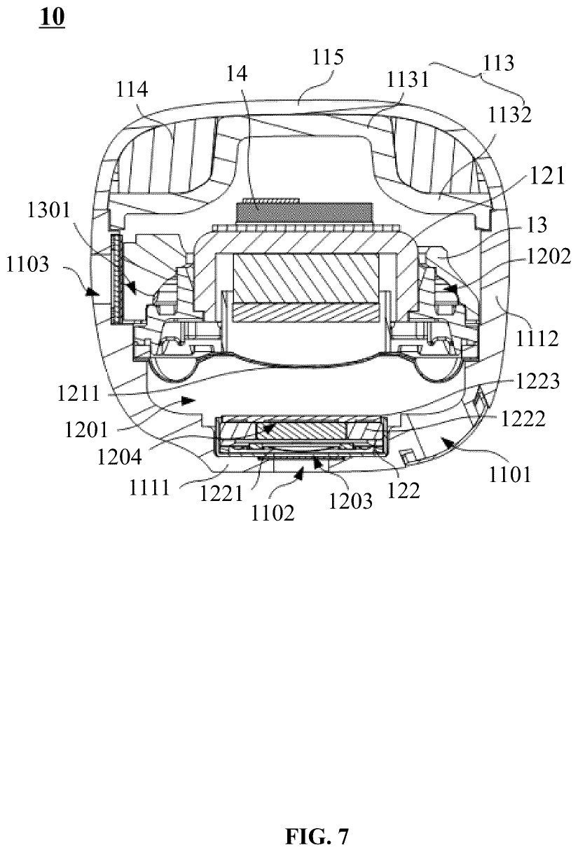

Please refer to FIG. 6 and FIG. 7, FIG. 6 is a cross-sectional view of the earphone 100 in FIG. 1 taken along a line VI-VI according to some embodiments of the present disclosure. FIG. 7 is a cross-sectional view of the earphone 100 in FIG. 1 taken along a line VII-VII according to some embodiments of the present disclosure. The core module 10 includes a core housing 11, a speaker assembly 12, and a main control circuit board 13. The core housing 11 may be connected to the hook structure 20. The core housing 11 may have a mounting space 101 for mounting the speaker assembly 12 and the main control circuit board 13. Of course, other electronic components may also be mounted therein, which will not be elaborated here. The speaker assembly 12 and the main control circuit board 13 may be disposed in the core housing 11, e.g., in the mounting space 101. The main control circuit board 13 may be electrically connected to the speaker assembly 12 and is configured to control the operation of the speaker assembly 12. It is understandable that the core housing 11 serves as an external housing of the core module 10. Therefore, the inner side surface IS, the outer side surface OS, and the connection surface (e.g., the lower side surface LS, the upper side surface US, and the rear side surface RS) of the aforementioned core module 10 are all formed on the core housing 11, serving as outer surfaces of the core housing 11. The aforementioned length direction Y may be defined as a direction in which the core housing 11 faces toward or away from the back of the head in the wearing state, the width direction Z may be defined as a direction in which the core housing 11 faces toward or away from the top of the head in the wearing state, and the thickness direction X may be defined as a direction in which the core housing 11 faces toward or away from the user's ear in the wearing state. In some embodiments, the length direction Y may be defined as a direction from the connection end of the core housing 11 to the free end of the core module 10, and the thickness direction X may be defined as a direction in which the core housing 11 faces toward or away from the user's ear in the wearing state.

The core housing 11 may include a first housing 111 and a second housing 112 that are fastened together along the thickness direction X to form the mounting space 101. The first housing 111 is closer to the ear 200 than the second housing 112 in a wearing state. A parting surface 102 is provided between the first housing 111 and the second housing 112 to simplify the structure of the core housing 11 and reduce processing costs. Certainly, the core housing 11 may also have other structural forms and is not limited to the embodiments listed in the present disclosure.

In some embodiments, a first sound outlet 1101 and a second sound outlet 1102 communicating with the mounting space 101 may be provided on the core housing 11. The first sound outlet 1101 and the second sound outlet 1102 may cooperate with the speaker assembly 12, respectively, making sound waves generated by the speaker assembly 12 propagate through the first sound outlet 1101 and the second sound outlet 1102, respectively. The first sound outlet 1101 and the second sound outlet 1102 may not communicate with each other. Providing two sound outlets may improve the auditory experience of the speaker assembly 12 and avoid sound wave interference between a plurality of speakers.

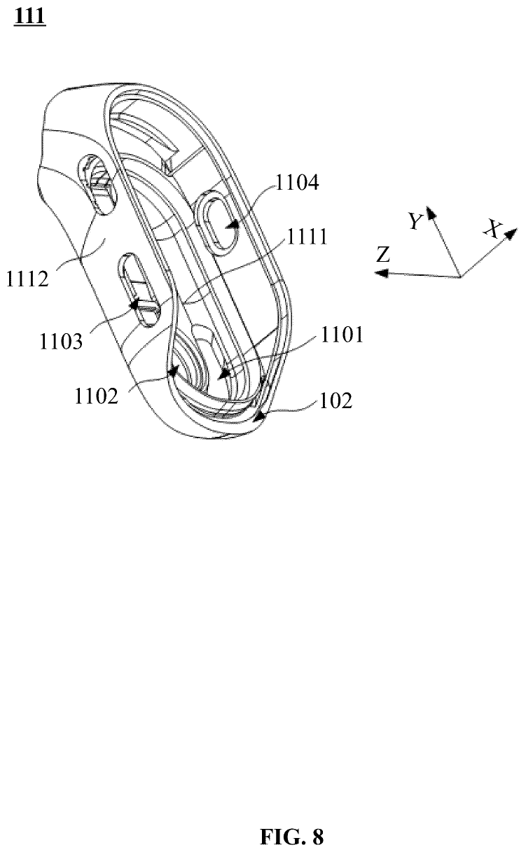

Please refer to FIG. 8, FIG. 8 is a schematic diagram illustrating a structure of the first housing 111 in FIG. 6 according to some embodiments of the present disclosure. In some embodiments, at least one of the first sound outlet 1101 or the second sound outlet 1102 may be provided on the first housing 111. For example, both the first sound outlet 1101 and the second sound outlet 1102 may be provided on a bottom wall 1111 of the first housing 111. In some embodiments, the bottom wall 1111 may correspond to the inner side surface IS of the core module 10. When a wearing manner of the core module 10 extending into the cavum concha 2002 is adopted, since the cavum concha 2002 has a certain volume and depth, and after the free end FE extends into the cavum concha 2002, a portion of the inner side surface IS corresponding to the bottom wall 1111 of the core housing 11 may have a certain distance from the cavum concha 2002. Furthermore, the core housing 11 and the cavum concha 2002 may cooperate to form an auxiliary cavity communicating with the ear canal 2001 in the wearing state. The first sound outlet 1101 and the second sound outlet 1102 are at least partially located within the auxiliary cavity. Furthermore, in the wearing state, sound waves generated by the speaker assembly 12 and propagating out through the first sound outlet 1101 and the second sound outlet 1102 are confined by the auxiliary cavity. That is, the auxiliary cavity may concentrate the sound waves, allowing more sound waves to propagate into the ear canal 2001, thereby increasing the volume and quality of a sound heard by the user in a near field, which is beneficial for improving the acoustic effect of the earphone 100.

In some embodiments, both the first sound outlet 1101 and the second sound outlet 1102 are closer to the free end FE than to the connection end CE, making that the first sound outlet 1101 and the second sound outlet 1101 are closer to the ear canal 2001 in the wearing state. In some embodiments, the core module 10 is configured not to block the ear canal 2001 in the wearing state, making that the auxiliary cavity may be configured as semi-open.

In some embodiments, the first housing 111 includes a first side wall 1112 extending from an edge of the bottom wall 1111 toward a side of the bottom wall 1111 close to the second housing 112. At least one of the first sound outlet 1101 or the second sound outlet 1102 may not be provided on the bottom wall 1111, but may be provided on a side of the first side wall 1112 corresponding to the lower side surface LS, or at a corner between the first side wall 1112 and the bottom wall 1111, or even at other parts of the core housing 11, e.g., at the inner side surface IS, the lower side surface LS, or a corner between the inner side surface IS and the lower side surface LS.

Please refer to FIG. 7 and FIG. 8, the first housing 111 may be a plastic component, or a structure composed of or compounded from a plurality of materials. Certainly, the first housing 111 may also be a housing structure made of other materials. In some embodiments, at least one of a pressure relief hole 1103 or a tuning hole 1104 may be provided on the first side wall 1112. That is, at least one of the pressure relief hole 1103 or the tuning hole 1104 may be provided on the upper side surface US or the lower side surface LS corresponding to the core housing 11. Furthermore, at least one of an acoustic mesh or a protective steel mesh, etc., may be provided at the pressure relief hole 1103 or the tuning hole 1104.

It is understandable that acoustic holes such as the pressure relief hole 1103 and the tuning hole 1104 may be adjusted according to the needs of those skilled in the art and provided on the core housing 11, e.g., on the first housing 111. For example, the pressure relief hole 1103 and the tuning hole 1104 may be provided at positions on the first housing 111 that cooperate with the speaker assembly 12, and are not limited to the positions listed here. For example, the pressure relief hole 1103 and the tuning hole 1104 may be provided at positions on the first side wall 1112 that cooperate with the speaker assembly 12, and are not limited to the positions listed here. For example, the pressure relief hole 1103 and the tuning hole 1104 may be provided on opposite sides of the first side wall 1112 along the width direction Z, respectively.

Additionally, since the first sound outlet 1101, the pressure relief hole 1103, and the tuning hole 1104 may all be provided on the first housing 111, the structure of the first housing 111 is simpler, which is beneficial for reducing processing costs. Furthermore, since the pressure relief hole 1103 and the tuning hole 1104 are provided on opposite sides of the first side wall 1112 along the width direction Z, respectively, the aforementioned parting surface 102 may be symmetrically disposed about a reference plane perpendicular to the width direction Z, which is beneficial for improving the appearance quality of the core module 10.

Moreover, the acoustic holes are not limited to the pressure relief hole 1103 and the tuning hole 1104, and may also include other acoustic holes cooperating with the speaker assembly 12. In some embodiments, at least one of the pressure relief hole 1103 and the tuning hole 1104 may be omitted.

Please refer to FIG. 6, the second housing 112 may be a plastic component, or may be a structure composed of or compounded from a plurality of materials. Certainly, the second housing 112 may also be a housing structure made of other materials. The parting surface 102 between the second housing 112 and the first housing 111 (e.g., the first side wall 1112) extends or bends towards a side where the first housing 111 is located along a direction approaching the free end FE. The second housing 112 may include a top wall 1121 opposite to the first housing 111 (for example, the bottom wall 1111). The second housing 112 may also include a second side wall 1122 connected to the top wall 1121 and engaged with the first housing 111 (for example, the first side wall 1112).

It is understandable that, due to the configuration of the second side wall 1122, the free end FE is tapered in a direction away from the connection end CE, which facilitates matching the contour of the ear of the user, improving the wearing experience.

Please refer to FIG. 6 and FIG. 7, the speaker assembly 12 may generate sound waves after being powered on. The sound waves may be transmitted out through at least one of the first sound outlet 1101 or the second sound outlet 1102 to facilitate entry into the external ear canal 2001. The speaker assembly 12 may be coupled to the main control circuit board 13 to allow operation under the control of the main control circuit board 13. The speaker assembly 12 may include a first speaker 121 and a second speaker 122 disposed within the core housing 11, for example, within the mounting space 101. The first speaker 121 and the second speaker 122 may be respectively coupled to the main control circuit board 13 to allow operation under the control of the main control circuit board 13. Sound waves generated by the first speaker 121 may be transmitted out through the first sound outlet 1101. Sound waves generated by the second speaker 122 may be transmitted out through the second sound outlet 1102. In some embodiments, the sound waves generated by the first speaker 121 may also be transmitted out through the acoustic holes, such as the pressure relief hole 1103 and the tuning hole 1104. Certainly, it is also possible to have only one of the pressure relief hole 1103 or the tuning hole 1104 cooperate with the first speaker 121.

Please refer to FIG. 6 and FIG. 7, the first speaker 121 may be fixed within the core housing 11. An axial direction of the first speaker 121 may be set along the thickness direction X. In some embodiments, the first speaker 121 may be fixed to the first housing 111, for example, the bottom wall 1111. Certainly, the first speaker 121 may also be fixed to the first side wall 1112 or other parts of the core housing 11.

In some embodiments, the first speaker 121 may have a strip-like structure to match the core housing 11, for example, the mounting space 101. That is, the first speaker 121 may be disposed to extend in the direction from the connection end CE to the free end FE. The configuration facilitates the placement of a sufficiently large first speaker 121 within the core housing 11, for example, within the mounting space 101, thereby enhancing the volume of sound produced by the earphone 100, optimizing the layout, and improving space utilization.

Please refer to FIG. 7, the first speaker 121 may include a first diaphragm 1211 for vibrating to produce a sound. The first speaker 121 may also include a first magnetic circuit system for driving the first diaphragm 1211 to vibrate to produce the sound, and a support member for carrying the first diaphragm 1211 and the first magnetic circuit system. Within the understanding of those skilled in the art, the technical principle of the first magnetic circuit system driving the first diaphragm 1211 to vibrate to produce the sound will not be repeated.

The first speaker 121 and the core housing 11 cooperate to form a first front cavity 1201 on a front side of the first diaphragm 1211 of the first speaker 121 and a first rear cavity 1202 on a rear side of the first diaphragm 1211 within the core housing 11 (e.g., within the mounting space 101). The front side of the first diaphragm 1211 refers to a side of the first diaphragm 1211 away from the first magnetic circuit system. The rear side of the first diaphragm 1211 refers to a side of the first diaphragm 1211 facing towards the first magnetic circuit system. In some embodiments, the first front cavity 1201 is located on a side of the first speaker 121 facing towards the inner side surface IS of the core housing 11, for example, towards a side of the bottom wall 1111 of the first housing 111. The first rear cavity 1202 is located on a side of the first speaker 121 away from the inner side surface IS, for example, away from the side of the bottom wall 1111 of the first housing 111. In some embodiments, the first front cavity 1201 may be in communication with the first sound outlet 1101, which allows sound waves generated by the first speaker 121 to be transmitted through the first sound outlet 1101.

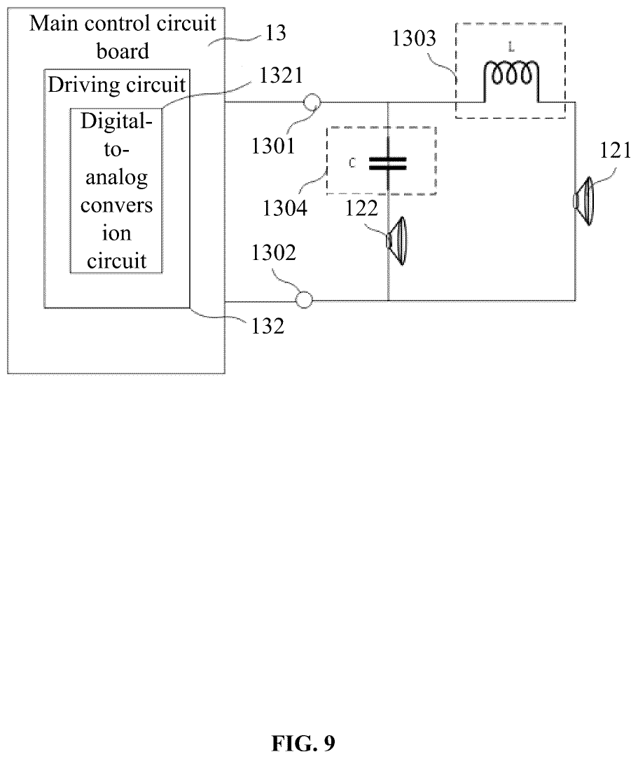

Please refer to FIG. 9, FIG. 9 is a circuit schematic diagram of the speaker assembly 12 according to some embodiments of the present disclosure. The speaker assembly 12 may include a first connection terminal 1301 and a second connection terminal 1302, respectively, electrically connected to the main control circuit board 13. The first speaker 121 may be connected in series between the first connection terminal 1301 and the second connection terminal 1302. Therefore, the first speaker 121 may produce the sound under the control of the main control circuit board 13. In some embodiments, the speaker assembly 12 may further include a low-pass frequency divider 1303 connected in series with the first speaker 121 and is between the first connection terminal 1301 and the second connection terminal 1302. The low-pass frequency divider 1303 implements low-pass filtering, causing the first speaker 121 to receive only electrical signals of lower frequency bands. Consequently, the first speaker 121 outputs more sounds in the lower frequency bands. The low-pass frequency divider 1303 performs frequency-dividing processing on an audio driving signal to generate an electrical signal input to the first speaker 121. Certainly, when the low-pass frequency divider 1303 does not perform the frequency-dividing processing on the audio driving signal, the audio driving signal is the electrical signal input to the first speaker 121. In some embodiments, the audio driving signal is provided by the main control circuit board 13. The low-pass frequency divider 1303 may perform first-order frequency-dividing on the audio driving signal provided by the main control circuit board 13 to the first speaker 121 to reduce circuit complexity. In some embodiments, the low-pass frequency divider 1303 may include a frequency-dividing inductor L. A count of frequency-dividing inductors L may be at least one. In this case, the low-pass frequency divider 1303 may perform the frequency-dividing processing on the audio driving signal provided by the main control circuit board 13 to the first speaker 121.

In the present disclosure, the low-pass frequency divider 1303 may be a first-order frequency divider or a multi-order frequency divider. In some embodiments of the present disclosure, the low-pass frequency divider 1303 is a first-order frequency divider. That is, the low-pass frequency divider 1303 includes one frequency-dividing inductor L. Thus, the design of the low-pass frequency divider 1303 is simpler and the cost is lower. Moreover, when selecting the count of the frequency-dividing inductors L, the first-order frequency-dividing uses fewer frequency-dividing inductors L, which further reduces the occupation of the core housing 11 (for example, the mounting space 101), making the core module 10 smaller. When the core module 10 cooperates with the main control circuit board 13, the requirements for the main control circuit board 13 may be reduced, making the main control circuit board 13 smaller.

In some embodiments, the audio driving signal provided by the main control circuit board 13 may be directly transmitted to the first speaker 121. That is, the audio driving signal may be directly input to the first speaker 121 without undergoing the frequency-dividing processing. In some embodiments, a frequency range of the audio driving signal may be the same as an operating frequency range of the first speaker 121.

In some embodiments, the main control circuit board 13 includes a driving circuit 132. The driving circuit 132 is connected to the first speaker 121 and the second speaker 122 to drive the first speaker 121 and the second speaker 122 to operate. In some embodiments, the driving circuit 132 may include a digital-to-analog conversion circuit 1321. The first speaker 121 and the second speaker 122 are connected to the digital-to-analog conversion circuit 1321. The digital-to-analog conversion circuit 1321 enables simultaneous driving of the first speaker 121 and the second speaker 122. That is, the driving circuit 132 may simultaneously input the same audio driving signal to the first speaker 121 and the second speaker 122 to drive the first speaker 121 and the second speaker 122 to operate.

The second speaker 122 is disposed within the mounting space 101 of the core housing 11. Please refer to FIG. 6 and FIG. 7, the second speaker 122 may be fixed to the first housing 111, for example, the bottom wall 1111. In this case, an axial direction of the second speaker 122 may be along the thickness direction X. In some embodiments, the second speaker 122 may be located within the first front cavity 1201 of the first speaker 121. In this case, the axial direction of the first speaker 121 and the axial direction of the second speaker 122 are parallel. In other embodiments, the second speaker 122 may also be fixed to the first side wall 1112 or other parts of the core housing 11. The axial direction of the second speaker 122 may also be set to intersect with the thickness direction X.

In some embodiments, the second speaker 122 may be embedded in an inner wall of the core housing 11. For example, a groove may be formed on the inner wall of the core housing 11 to accommodate the second speaker 122, thereby achieving an embedded configuration of the second speaker 122. Please refer to FIG. 7, the groove accommodating the second speaker 122 may be formed on the bottom wall 1111 of the first housing 111. In this case, in the wearing state, the second speaker 122 is located on the inner wall of the core module 10 corresponding to the inner side surface IS, and the second speaker 122 is closer to the ear of the user. As another example, the groove accommodating the second speaker 122 may be formed on a lower side surface of the aforementioned core module 10 or inner walls of a plurality of connecting surfaces to adapt to different wearing scenarios and provide a better auditory experience for the user.

Please refer to FIG. 7, the second speaker 122 may include a second diaphragm 1221 for vibrating to produce a sound, a second magnetic circuit system 1222 for driving the second diaphragm 1221 to produce the sound, and a speaker housing 1223 for carrying and mounting the second diaphragm 1221 and the second magnetic circuit system 1222. Within the understanding of those skilled in the art, the technical principle of the second magnetic circuit system 1222 driving the second diaphragm 1221 to vibrate to produce the sound will not be repeated.

The second speaker 122 is located within the core housing 11 (e.g., the mounting space 101) and cooperates with the core housing 11. A front side of the second diaphragm 1221 of the second speaker 122 cooperates with the core housing 11 to form a second front cavity 1203. A rear side of the second diaphragm 1221 cooperates with the speaker housing 1223 to form a second rear cavity 1204. The front side of the second diaphragm 1221 refers to a side of the second diaphragm 1221 away from the second magnetic circuit system 1222. The rear side of the second diaphragm 1221 refers to a side of the second diaphragm 1221 facing towards the second magnetic circuit system 1222. When the second speaker 122 is located on the inner wall of the core module 10 corresponding to the inner side surface IS, the second front cavity 1203 is located on a side of the second speaker 122 facing towards the inner side surface IS, and the second rear cavity 1204 is located on a side of the second speaker 122 away from the inner side surface IS.

The second front cavity 1203 may be in communication with the second sound outlet 1102, which allows sound waves generated by the second speaker 122 to be transmitted through the second sound outlet 1102. In some embodiments, the core housing 11 may include a structure, such as an isolation plate, disposed between the second speaker 122 and the first speaker 121. The isolation plate isolates a cavity coupled to the first speaker 121 from a cavity coupled to the second speaker 122. Thus, the first sound outlet 1101 is only in communication with the first front cavity 1201, and the second sound outlet 1102 is only in communication with the second front cavity 1203. In some embodiments, the second speaker 122 may be located farther from the connection end CE and closer to the free end FE to cooperate with the second sound outlet 1102.

In some embodiments, the speaker housing 1223 is a housing structure distinct from the core housing 11, which facilitates the flexible installation of the second speaker 122 on the core module 10. In some embodiments, the speaker housing 1223 includes a support member that carries the second diaphragm 1221 and the second magnetic circuit system 1222, and a cover connected to the core housing 11 to fix the second speaker 122. The cover is provided with a sound hole, which is in communication with the second sound outlet 1102. In some embodiments, the speaker housing 1223 includes only the support member that carries the second diaphragm 1221 and the second magnetic circuit system 1222, and connects to the core housing 11 through the support member to fix the second speaker 122.

At least a portion of a frequency range of the sound output by the first speaker 121 is lower than a frequency range of the sound output by the second speaker 122. In some embodiments, the frequency range of the sound output by the first speaker 121 may be entirely less than the frequency range of the sound output by the second speaker 122. In other embodiments, at least a portion of the frequency range of the sound output by the first speaker 121 overlaps with the frequency range of the sound output by the second speaker 122, and a maximum frequency of the sound output by the first speaker is lower than a maximum frequency of the sound output by the second speaker, making at least a portion of a frequency band of the sound output by the second speaker 122 be higher than a frequency band of the sound output by the first speaker 121.

In some embodiments, the frequency range of the sound output by the first speaker 121 may include 20 Hz to 5 kHz. The frequency range of the sound output by the second speaker 122 may include 5 kHz to 20 kHz. In some embodiments, the frequency range of the sound output by the first speaker 121 and the frequency range of the sound output by the second speaker 122 may have different standards based on actual situations. For example, the frequency range of the sound output by the first speaker 121 may also refer to a frequency range not higher than 1 kHz, e.g., 1 Hz to 1 kHz, 100 Hz to 800 Hz, etc.

In some embodiments, the frequency range of the sound output by the first speaker 121 may be a low-frequency band or a mid-low-frequency band. The frequency range of the sound output by the second speaker 122 may be a high-frequency band or a mid-high-frequency band. Accordingly, the first speaker 121 may be referred to as a low-frequency speaker, and the second speaker 122 may be referred to as a high-frequency speaker. The low-frequency band may be at least a portion of a frequency band substantially from 20 Hz to 500 Hz, or at least a portion of a frequency band substantially from 20 Hz to 3 kHz. The high-frequency band may be at least a portion of a frequency band substantially from 5 kHz to 20 kHz, or at least a portion of a frequency band from 6 kHz to 16 kHz. The mid-frequency band may be between the low-frequency band and the high-frequency band, and may partially overlap with at least one of the low-frequency band or the high-frequency band. Accordingly, the mid-low-frequency band may be a combination of the low-frequency band and the mid-frequency band. The mid-high-frequency band may be a combination of the mid-frequency band and the high-frequency band.

It should be understood that the division of the aforementioned frequency bands is merely given as an example to roughly indicate intervals. Definitions of the aforementioned frequency bands may vary depending on different industries, different application scenarios, and different classification standards. For example, in some other application scenarios, the low-frequency band refers to a frequency band substantially from 20 Hz to 80 Hz, the mid-low-frequency band may refer to a frequency band substantially between 80 Hz and 160 Hz, the mid-frequency band may refer to a frequency band substantially from 160 Hz to 1280 Hz, the mid-high-frequency band may refer to a frequency band substantially from 1280 Hz to 2560 Hz, and the high-frequency band may refer to a frequency band substantially from 2560 Hz to 120 kHz.

In some embodiments, the main control circuit board 13 may provide identical audio driving signals to the first speaker 121 and the second speaker 122. In other words, the frequencies of electrical signals received by the first speaker 121 and the second speaker 122 may be the same. In this case, the second diaphragm 1221 of the second speaker 122 may vibrate under an electrical signal in a frequency band not higher than 200 Hz. If the first speaker 121 is the aforementioned low-frequency speaker and the second speaker 122 is the aforementioned high-frequency speaker, at least a portion of the frequency range of the sound output by the first speaker 121 is lower than the frequency range of the sound output by the second speaker 122. That is, a sound output effect of the first speaker 121 is better in a lower frequency band, and a sound output effect of the second speaker 122 is better in a higher frequency band.

In some embodiments, on a reference plane perpendicular to the axial direction of the first speaker 121, at least a portion of an orthogonal projection of the second speaker 122 on the reference plane overlaps with an orthogonal projection of the first speaker 121 on the reference plane. In some embodiments, on the reference plane perpendicular to the axial direction of the first speaker 121, the orthogonal projection of the second speaker 122 on the reference plane entirely overlaps with the orthogonal projection of the first speaker 121 on the reference plane, which optimizes the arrangement and improves space utilization. In some embodiments, the axial direction of the first speaker 121 may be a vibration direction of the first diaphragm 1211. In some embodiments, an axial direction of the second speaker 122 may point toward the first speaker 121. In some embodiments, the axial direction of the second speaker 122 may be parallel to the axial direction of the first speaker 121. That is, an angle between the axial direction of the second speaker 122 and the axial direction of the first speaker 121 may be 0°.

It may be understood that a positional relationship and a cooperative relationship between the second speaker 122 and the first speaker 121, and respective positional relationships and cooperative relationships with the core housing 11, may also be adjusted and changed, and are not limited to the embodiments listed herein.

Please refer to FIG. 7, the main control circuit board 13 may provide the audio driving signal to the second speaker 122, making that the second diaphragm 1221 of the second speaker 122 may vibrate under an electrical signal in a frequency band not higher than 200 Hz. When the second speaker 122 is the aforementioned high-frequency speaker, the sound output effect of the second speaker 122 is better in a higher frequency band but poorer in a lower frequency band, which may cause the second diaphragm 1221 of the second speaker 122 to exhibit distortion when vibrating under the electrical signal in the frequency band not higher than 200 Hz.

Please refer to FIG. 9, the second speaker 122 may be connected in series between the first connection terminal 1301 and the second connection terminal 1302, and thus may produce a sound under the control of the main control circuit board 13. In some embodiments, the speaker assembly 12 may further include a high-pass frequency divider 1304 connected in series with the second speaker 122 and is between the first connection terminal 1301 and the second connection terminal 1302, to achieve high-pass filtering through the high-pass frequency divider 1304. In some embodiments, the first connection terminal 1301 and the second connection terminal 1302 cooperate to receive the audio driving signal from the main control circuit board 13, enabling the high-pass frequency divider 1304 to perform the frequency-dividing processing on the audio driving signal to generate an electrical signal received by the second speaker 122. The arrangement allows the electrical signal received by the second speaker 122 to achieve attenuation in frequency bands below a frequency-dividing point, thereby reducing a sound pressure level of the sound output by the second speaker 122 in a low frequency band, which helps mitigate distortion phenomena that may occur when the second speaker 122 outputs the sound in a relatively low frequency band (e.g., below 200 Hz, such as 50 Hz to 100 Hz).

In some embodiments, the frequency-dividing point at which the high-pass frequency divider 1304 performs the frequency-dividing processing on the audio driving signal may be not lower than 6 kHz, making that the sound pressure level of the sound output by the second speaker 122 is attenuated at least below 6 kHz, and the second speaker 122 may achieve a good acoustic output effect in frequency bands above 6 kHz. In some embodiments, the frequency-dividing point at which the high-pass frequency divider 1304 performs the frequency-dividing processing on the audio driving signal may not be lower than 8 kHz. In some embodiments, the frequency-dividing point may be 8 kHz. Since the sound output effect of the first speaker 121 is poorer in higher frequency bands, the second speaker 122 may compensate for the sound pressure level in frequency bands above 8 kHz. In some embodiments, the frequency-dividing point at which the high-pass frequency divider 1304 performs the frequency-dividing processing on the audio driving signal may not be higher than 9 kHz, which avoids affecting the output of the second speaker 122 in the higher frequency bands, thereby ensuring sound output capability of the earphone across full frequency bands.

In some embodiments, the setting of the frequency-dividing point may cause the sound pressure level of the sound output by the second speaker 122 to be attenuated by not less than 20 dB in the low-frequency band (e.g., below 200 Hz, such as 50 Hz to 100 Hz), which alleviates the acoustic distortion that occurs when the second speaker 122 outputs the sound in the lower frequency bands. In some embodiments, the setting of the frequency-dividing point may cause the sound pressure level of the sound output by the second speaker 122 to be attenuated by not less than 30 dB in the low-frequency band (e.g., below 200 Hz, such as 50 Hz to 100 Hz), which alleviates the acoustic distortion that occurs when the second speaker 122 outputs the sound in the lower frequency bands.

In some embodiments, the frequency-dividing point may be set near a resonant frequency of the second speaker 122, which may cause the electrical signal received by the second speaker 122 below the frequency-dividing point to be attenuated, thereby improving the acoustic distortion existing when the second speaker 122 outputs the sound in the low-frequency band (e.g., below 200 Hz). In some embodiments, a ratio of the resonant frequency of the second speaker 122 to the frequency-dividing point is between 0.75 and 1.25. In some embodiments, the ratio of the resonant frequency of the second speaker 122 to the frequency-dividing point is between 0.9 and 1.1.

In some embodiments, the resonant frequency of the second speaker 122 may not be lower than 6 kHz. The second diaphragm 1221 may vibrate under at least an electrical signal in a frequency band of 1 kHz to 20 kHz. In some embodiments, the resonant frequency of the second speaker 122 may be between 6 kHz and 9 kHz.

In some embodiments, the aforementioned high-pass frequency divider 1304 may be configured to perform first-order frequency-dividing processing on the audio driving signal from the main control circuit board 13, which reduces circuit complexity while alleviating the acoustic distortion existing in the low-frequency output of the second speaker 122. In this case, the high-pass frequency divider 1304 may include a frequency-dividing capacitor C, and the count of the frequency-dividing capacitors C is one. The arrangement reduces the occupation of space, such as the mounting space 101, in the core housing 11, making the core module 10 smaller. When cooperating with the main control circuit board 13, it may reduce the requirements for the main control circuit board 13, making the main control circuit board 13 smaller. It may be understood that, in other embodiments of the present disclosure, the high-pass frequency divider 1304 may also be a multi-order frequency divider, and may be configured to perform multi-order frequency-dividing processing on the audio driving signal from the main control circuit board 13, achieving a better low-frequency filtering effect and further alleviating the acoustic distortion of the output of the second speaker 122 in the low frequency band.

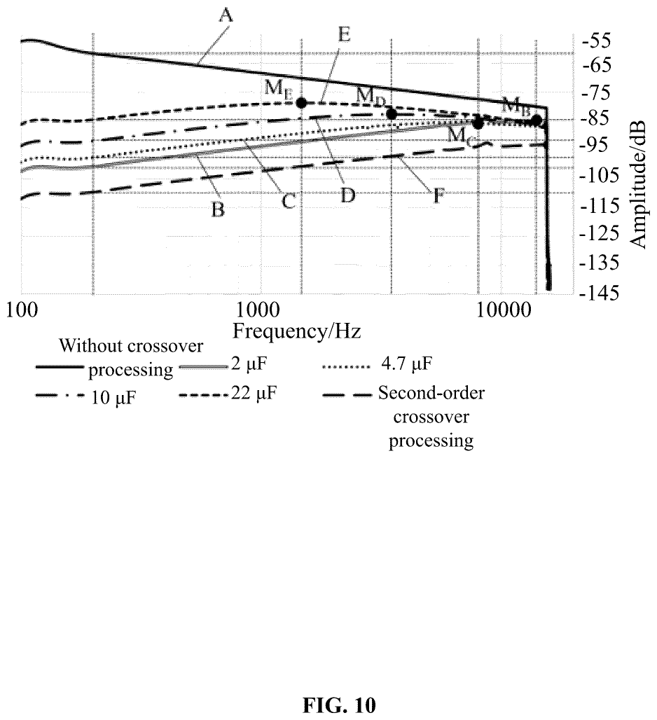

Please refer to FIG. 10, FIG. 10 is a schematic diagram illustrating frequency division effects of the second speaker 122 under different frequency-dividing processing conditions when adjusting the high-pass frequency divider 1304 according to some embodiments of the present disclosure. Curve A represents an electrical signal curve received by the second speaker 122 when the high-pass frequency divider 1304 is not provided, i.e., the audio driving signal curve. Curves B, C, D, and E represent electrical signal curves received by the second speaker 122 after performing first-order frequency division using the high-pass frequency divider 1304. Corresponding to curve B, the capacitance of the frequency-dividing capacitor C of the high-pass frequency divider 1304 is 2 μF. Corresponding to curve C, the capacitance of the frequency-dividing capacitor C of the high-pass frequency divider 1304 is 4.6 μF. Corresponding to curve D, the capacitance of the frequency-dividing capacitor C of the high-pass frequency divider 1304 is 10 μF. Corresponding to curve E, the capacitance of the frequency-dividing capacitor C of the high-pass frequency divider 1304 is 22 μF. Curve F represents an electrical signal curve received by the second speaker 122 after performing second-order frequency division using the high-pass frequency divider 1304.

Please refer to FIG. 10, near 200 Hz, a frequency response amplitude corresponding to curve A is approximately −62 dB, a frequency response amplitude corresponding to curve B is approximately −101 dB, a frequency response amplitude corresponding to curve C is approximately −98 dB, a frequency response amplitude corresponding to curve D is approximately −92 dB, and a frequency response amplitude corresponding to curve E is approximately −85 dB. That is, compared to curve A representing the signal without the frequency-dividing processing, the amplitude of signal components below 200 Hz in the electrical signal corresponding to curve B is attenuated by approximately 39 dB, the amplitude of signal components below 200 Hz in the electrical signal corresponding to curve C is attenuated by approximately 36 dB, the amplitude of signal components below 200 Hz in the electrical signal corresponding to curve D is attenuated by approximately 30 dB, and the amplitude of signal components below 200 Hz in the electrical signal corresponding to curve E is attenuated by approximately 23 dB. That is, compared to the audio driving signal without the frequency-dividing processing (corresponding to curve A), the amplitudes of the signal components below 200 Hz in the electrical signals after the frequency-dividing processing using a single capacitor element (corresponding to curves B, C, D, and E) are all significantly attenuated. Thus, low-frequency components in the electrical signal received by the second speaker 122 are effectively suppressed, and the electrical signals after the frequency-dividing processing may effectively reduce the occurrence of acoustic distortion when the second speaker 122 outputs the sound.

In some embodiments, the value of the capacitance of the frequency-dividing capacitor C may correspond to a theoretical frequency-dividing point:

$$C = \frac{1}{2 π fz} , \qquad ( 1 )$$

where f denotes a division frequency, z denotes a rated impedance of the second speaker 122, and C denotes a capacitance of the frequency-dividing capacitor C. It should be understood that when there are a plurality of frequency-dividing capacitors, the capacitance C obtained through calculation by using formula (1) is an equivalent capacitance value of the plurality of frequency-dividing capacitors.

Due to a magnetic circuit system and a coil existing in the structure of the second speaker 122, the coil acts as an inductor and affects the frequency-dividing point, causing a deviation between an actual frequency-dividing point and a theoretical frequency-dividing point. As shown in FIG. 10, an actual frequency-dividing point corresponding to the curve B (i.e., a frequency corresponding to a maximum point Mb of the curve B) is near 15 kHz, an actual frequency-dividing point corresponding to the curve C (i.e., a frequency corresponding to a maximum point Mc of the curve C) is near 8 kHz, an actual frequency-dividing point corresponding to the curve D (i.e., a frequency corresponding to a maximum point Md of the curve D) is near 3.4 kHz, and an actual frequency-dividing point corresponding to the curve E (i.e., a frequency corresponding to a maximum point Me of the curve E) is near 1.5 kHz. Based on formula (1), the curve C, the curve D, and the curve E, it may be known that the actual frequency-dividing point is negatively correlated with the capacitance value of the frequency-dividing capacitor.

Please refer to FIG. 10, a portion of the curve F in a higher frequency band (e.g., above 8 kHz) also has a large attenuation amplitude, which corresponds to a large attenuation amplitude of the signal components in the higher frequency band in the electrical signal obtained through the second-order frequency-dividing processing, affecting a normal output of the second speaker 122 in the higher frequency band. Additionally, using two frequency-dividing capacitors causes the structure of the main control circuit board 13 to be more complex, thereby increasing manufacturing costs and the volume of the finally manufactured earphone 100. In summary, to simplify a circuit and reduce system complexity, and to ensure the normal output of the second speaker 122 in the higher frequency band, the high-pass frequency divider 1304 may use the first-order frequency-dividing processing, that is, a count of the frequency-dividing capacitor connected in series with the second speaker 122 may be one.

In some embodiments, if a count of the frequency-dividing capacitor connected in series with the second speaker 122 is one, in order to improve a frequency division effect and ensure the normal output of the second speaker 122 in the higher frequency band, a capacitance value range of the frequency-dividing capacitor may be 4.2 μF-5.2 μF. In some embodiments, to further improve the frequency division effect and ensure the normal output of the second speaker 122 in the higher frequency band, the capacitance value range of the frequency-dividing capacitor may be 4.4 μF-5.0 μF. In some embodiments, to further improve the frequency division effect and ensure the normal output of the second speaker 122 in the higher frequency band, the capacitance value range of the frequency-dividing capacitor may be 4.5 μF-4.8 μF.

In some embodiments, the second rear cavity 1204 of the second speaker 122 is in a closed state and is not connected to outside, which causes a phenomenon of air pressure imbalance between the second front cavity 1203 and the second rear cavity 1204, and further causes acoustic distortion when the second speaker 122 outputs the sound in the lower frequency band (e.g., below 200 Hz, e.g., 50 Hz to 100 Hz).

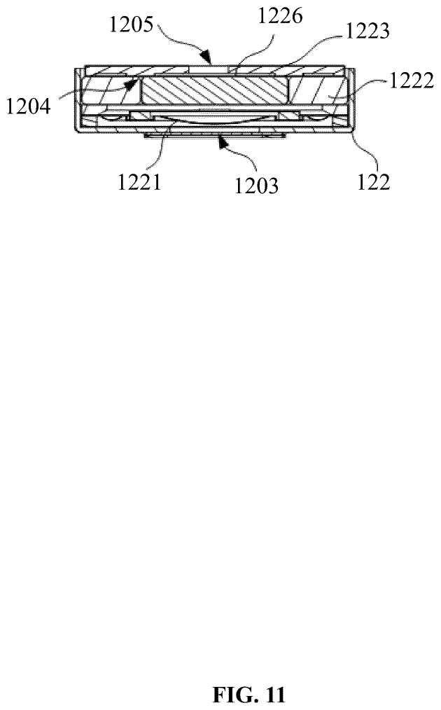

Please refer to FIG. 11, FIG. 11 is a schematic diagram illustrating the structure of the second speaker 122 in FIG. 7 according to some embodiments of the present disclosure. The speaker housing 1223 of the second speaker 122 is provided with a communication hole 1205 for communicating the second rear cavity 1204 with outside of the second speaker 122, to alleviate the phenomenon of air pressure imbalance between the second front cavity 1203 and the second rear cavity 1204 caused by closure of the second rear cavity 1204, thereby alleviating the acoustic distortion when the second speaker 122 outputs the sound in the lower frequency band (e.g., below 200 Hz, e.g., 50 Hz to 100 Hz) caused by the air pressure imbalance.

In some embodiments, the communication hole 1205 penetrates through the speaker housing 1223 to communicate with the second rear cavity 1204. For example, the communication hole 1205 may penetrate through a support frame of the speaker housing 1223 and communicate with the second rear cavity 1204, and the support frame is located on a side of the speaker housing 1223 away from the second front cavity 1203. If the second speaker 122 is disposed in the first front cavity 1201 of the first speaker, the communication hole 1205 may allow the first front cavity 1201 and the second rear cavity 1204 to communicate. Because the frequency range of the sound output by the second speaker 122 is high, and high-frequency sound waves have a characteristic of sharp directivity, when the first front cavity 1201 and the second rear cavity 1204 communicate, sound waves radiated from the second rear cavity 1204 through the communication hole 1205 rarely radiate toward the second front cavity 1203 again. Therefore, provision of the communication hole 1205 does not affect the sound waves output by the first speaker 121, and thus does not affect the acoustic performance of the first speaker 121 while alleviating the acoustic distortion of the second speaker 122.

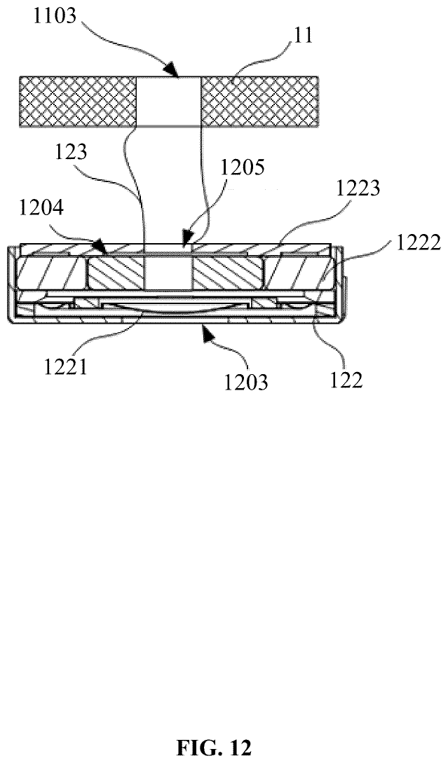

In some embodiments, please refer to FIG. 12, FIG. 12 is a schematic diagram illustrating a portion of the structure of a core module in FIG. 11 according to some embodiments of the present disclosure. The communication hole 1205 may further penetrate through the second magnetic circuit system 1222 and extend toward the second diaphragm 1221, making that the second magnetic circuit system 1222 surrounds the communication hole 1205, allowing the communication hole 1205 to communicate with the second rear cavity 1204, more directly alleviating the phenomenon of air pressure imbalance between the second front cavity 1203 and the second rear cavity 1204, improving a function of the second rear cavity 1204, and thereby alleviating the acoustic distortion.

In some embodiments, an acoustic impedance at the communication hole 1205 may be in a range of 5×10\hat{ }8 Pa·s/m-1.3×10\hat{ }9 Pa·s/m. The specific range avoids an increase in radiated sound pressure of the second rear cavity 1204 caused by an excessively small acoustic impedance, which would cause sound waves radiated from the first front cavity 1201 of the first speaker 121 to superimpose with sound waves radiated from the second rear cavity 1204 of the second speaker 122, resulting in an extremely complex phase of sound waves at a position of the acoustic hole and affecting a listening effect. The specific range also prevents an inability to balance air pressures on front and rear sides of the second diaphragm 1221 (i.e., air pressure between the second front cavity 1203 and the second rear cavity 1204) when the acoustic impedance is too large, failing to alleviate the sound distortion problem. In some embodiments, an acoustic mesh 1226 may be provided in the communication hole 1205 of the second speaker 122, to improve the acoustic impedance at the communication hole 1205 through the acoustic mesh 1226 and ensure the sensitivity of the second speaker 122.

In some embodiments, an aperture range of the communication hole 1205 may be 0.8 mm-1.2 mm, reducing the impact on air tightness caused by an excessively small communication hole 1205, and also reducing the impact on the sensitivity of the second speaker 122 caused by an excessively large communication hole 1205. In some scenarios, limiting the aperture of the communication hole 1205 may also reduce processing difficulty.

In some embodiments, in a radial direction of the second speaker 122 (for example, the second diaphragm 1221), the communication hole 1205 may be centrally disposed relative to the second speaker 122 (for example, the second diaphragm 1221). The radial direction may be perpendicular to the axial direction of the second speaker 122, that is, a direction perpendicular to a vibration direction of the second diaphragm 1221. Centrally disposed means that in the radial direction of the second speaker 122 (for example, the second diaphragm 1221), a distance between an axis of the communication hole 1205 and an axis of the second speaker 122 (for example, the second diaphragm 1221) is less than 10% of a length of the second speaker 122 (for example, the second diaphragm 1221).

In some embodiments, the communication hole 1205 may not communicate the second rear cavity 1204 with the first front cavity 1201, but may directly communicate with an acoustic hole (for example, the pressure relief hole 1103) provided on the core housing 11, to directly radiate high-frequency sound waves through the acoustic hole (for example, the pressure relief hole 1103). The arrangement may further reduce the impact of the sound waves radiated from the second rear cavity 1204 on the sound waves radiated from the first front cavity 1201. In some embodiments, the aforementioned acoustic hole communicated with the communication hole 1205 may be a portion of the first sound outlet 1101, or a portion of the acoustic hole (for example, the pressure relief hole 1103) communicated with the first rear cavity 1202, or an independent acoustic hole distinct from the other aforementioned acoustic holes. In this case, please refer to FIG. 12, the communication hole 1205 may be communicated with the aforementioned acoustic hole through a communication tube 123, to increase the sound path difference of transmission of the sound waves radiated from the second rear cavity 1204, attenuate the radiated sound waves, and avoid sound leakage affecting the auditory experience of the user.

It may be understood that provision of the communication hole 1205 may alleviate the acoustic distortion existing when the second speaker 122 outputs the sound in the low frequency band (e.g., below 200 Hz, e.g., 50 Hz to 100 Hz). Furthermore, the communication hole 1205 may cooperate with the high-pass frequency divider 1304 to alleviate the aforementioned acoustic distortion. Certainly, the high-pass frequency divider 1304 may also be omitted, and the aforementioned acoustic distortion may be alleviated only through the communication hole 1205. Additionally, when the communication hole 1205 cooperates with the high-pass frequency divider 1304, specific settings of the communication hole 1205 and specific settings of the high-pass frequency divider 1304 may be adjusted according to specific situations.

Please refer to FIG. 9, the driving circuit 132 may be provided on the main control circuit board 13 to implement driving of the speaker assembly 12, for example, the first speaker 121 and the second speaker 122. Further, the driving circuit 132 may mainly include the digital-to-analog conversion circuit 1321, and may certainly also include a power amplification circuit, a processor, etc. How to form the driving circuit 132 using the digital-to-analog conversion circuit 1321 and other circuits is not described in detail herein.

The driving circuit 132 may be electrically connected to connection terminals, for example, the first connection terminal 1301 and the second connection terminal 1302, and other connection terminals, to achieve electrical connection with the speaker assembly 12 (for example, the first speaker 121 and the second speaker 122) to drive the speaker assembly 12 (for example, the first speaker 121 and the second speaker 122). That is, the low-pass frequency divider 1303 (for example, the frequency-dividing inductor L) may be disposed between the driving circuit 132 and the first speaker 121. The high-pass frequency divider 1304 (for example, the capacitor C) may be disposed between the driving circuit 132 and the second speaker 122.

In some embodiments, the driving circuit 132 may implement simultaneous driving of the first speaker 121 and the second speaker 122 using only one digital-to-analog conversion circuit 1321. That is, the driving circuit 132 may input the same audio driving signal to the first speaker 121 and the second speaker 122.

It may be understood that the earphone 100 may further include electronic components that ensure normal operation of the earphone 100, for example, a battery, a sensor, an antenna, etc., and the electronic components may be disposed in at least one of the core module 10 or the hook structure 20 as needed, which is not described in detail.

In the several embodiments provided in the present disclosure, it should be understood that the disclosed method and device may be implemented in other manners. For example, the device embodiments described above are merely illustrative. For example, division of a module or a unit is merely a logical function division, and there may be another division manner in actual implementation. For example, a plurality of units or components may be combined or integrated into another system, or some features may be ignored or not performed.

Units described as separate components may or may not be physically separate, and components displayed as units may or may not be physical units, that is, may be located in one place, or may be distributed on a plurality of network units. Some or all of the units may be selected according to actual needs to achieve the objectives of the solutions of the implementations.

In addition, functional units in the various embodiments of the present disclosure may be integrated into one processing unit, or each of the units may exist alone physically, or two or more units are integrated into one unit. The foregoing integrated unit may be implemented in the form of hardware, or may be implemented in the form of a software functional unit.

The foregoing descriptions are merely specific embodiments of the present disclosure, but are not intended to limit the protection scope of the present disclosure. Any equivalent structure or equivalent process transformation made by using the content of the specification and accompanying drawings of the present application, or direct or indirect application in other related technical fields shall fall within the protection scope of the present disclosure.

What is claimed is:

1. An earphone, comprising: a core housing, a first speaker, a second speaker, and a driving circuit, wherein
the core housing accommodates the first speaker and the second speaker;
the driving circuit is configured to drive the first speaker and the second speaker;
at least a portion of a frequency band of a sound output by the first speaker is lower than a frequency band of a sound output by the second speaker;
the first speaker includes a first diaphragm, the first diaphragm and the core housing cooperating to form a first front cavity and a first rear cavity located on two sides of the first diaphragm;
the second speaker includes a second diaphragm and a speaker housing, the second diaphragm, the speaker housing, and the core housing cooperating to form a second front cavity and a second rear cavity located on two sides of the second diaphragm;
the core housing is provided with a first sound outlet for conducting a sound from the first front cavity to outside of the core housing and a second sound outlet for conducting a sound from the second front cavity to the outside of the core housing; and
the second speaker is further provided with a communication hole for communicating the second rear cavity with outside of the second speaker.

2. The earphone of claim 1, wherein when the driving circuit drives the second speaker, an operating frequency of the driving circuit includes a frequency band not higher than 200 Hz.

3. The earphone of claim 1, wherein the driving circuit is configured to simultaneously drive the first speaker and the second speaker through a digital-to-analog conversion circuit.

4. The earphone of claim 1, wherein a resonant frequency of the second speaker is not lower than 6 kHz.

5. The earphone of claim 1, wherein an acoustic impedance at the communication hole is in a range of 5×10⁸ Pa·s/m-1.3×10⁹ Pa·s/m.

6. The earphone of claim 1, wherein an acoustic mesh is provided at the communication hole.

7. The earphone of claim 1, wherein the second speaker is further provided with a second magnetic circuit system, the communication hole penetrates through the second magnetic circuit system, and an aperture of the communication hole is in a range of 0.8 mm-1.2 mm.

8. The earphone of claim 7, wherein in a radial direction of the second diaphragm, the communication hole is centrally provided relative to the second diaphragm.

9. The earphone of claim 1, wherein
on a reference plane perpendicular to an axial direction of the first speaker, at least a portion of an orthogonal projection of the second speaker on the reference plane overlaps with an orthogonal projection of the first speaker on the reference plane;
an axial direction of the second speaker points toward the first speaker; and
the communication hole is provided facing inside of the core housing.

10. The earphone of claim 9, further comprising:
a communication tube provided inside the core housing, wherein one end of the communication tube is in communication with the communication hole, and the other end of the communication tube is in communication with the outside of the core housing.

11. The earphone of claim 9, wherein the second speaker is located in the first front cavity, and the second rear cavity and the first front cavity are in communication with each other through the communication hole.

12. The earphone of claim 1, wherein an audio driving signal output by the driving circuit is configured to be directly input to the second speaker without undergoing frequency-dividing processing.

13. The earphone of claim 1, further comprising:
a high-pass frequency divider disposed between the driving circuit and the second speaker and configured to perform frequency division on an audio driving signal provided by the driving circuit to the second speaker, and a frequency-dividing point of the high-pass frequency divider is set to be not lower than 6 kHz.

14. The earphone of claim 13, wherein the frequency-dividing point of the high-pass frequency divider is set to be not higher than 9 kHz.

15. The earphone of claim 13, wherein the high-pass frequency divider is a one-order frequency divider consisting of a single capacitor.

16. The earphone of claim 13, wherein a frequency-dividing point of the high-pass frequency divider is set such that a sound pressure level of sound output by the second speaker is attenuated by not less than 20 dB in a low-frequency band.

17. The earphone of claim 13, wherein a ratio of a resonant frequency of the second speaker to the frequency-dividing point is between 0.75 and 1.25.

18. The earphone of claim 15, wherein the frequency-dividing point of the high-pass frequency divider is between 6 kHz and 9 kHz, and the sound pressure level of the sound output by the second speaker is attenuated by not less than 30 dB in a low-frequency band.

19. The earphone of claim 1, further comprising:
a low-pass frequency divider connected in series with the first speaker and is between the driving circuit and the first speaker, and configured to perform frequency division on an audio driving signal provided by the driving circuit to the first speaker.

20. The earphone according to claim 19, wherein the low-pass frequency divider is a one-order frequency divider consisting of a single inductor.
